(19) United States
(12) Patent Application Publication
(10) Pub. No.: US 2019/0138096 A1
(43) Pub. Date: May 9, 2019

(54) METHOD FOR DETECTING FACIAL EXPRESSIONS AND EMOTIONS OF USERS

(71) Applicant: Silicon Algebra Inc., Saratoga, CA (US)

(72) Inventors: Kevin Lee, Saratoga, CA (US); Quentin DeWolf, Seattle, WA (US); John P. Pella, Redmond, WA (US); Ivan Roberto Reyes, Redmond, WA (US)

(21) Appl. No.: 16/109,614

(22) Filed: Aug. 22, 2018

Related U.S. Application Data
(60) Provisional application No. 62/548,686, filed on Aug. 22, 2017.

(51) Int. Cl. G06F 3/01; G10L 25/18; G10L 25/51; G06K 9/00

(52) U.S. Cl. CPC G06F 3/015; G06K 9/00302; G10L 25/51; G10L 25/18

(57) ABSTRACT

A method for detecting facial emotions includes: recording a set of electromyograph signals through a set of sense electrodes arranged about a viewing window in a virtual reality headset; deducting a reference signal from each electromyograph signal in the set of electromyograph signals to generate a set of composite signals; for each composite signal in the set of composite signals, transforming the composite signal into a spectrum of electromyograph components; for each facial action unit in a set of facial action units, calculating a score indicating presence of the facial action unit in the user's facial musculature during the sampling interval based on the spectrum of electromyograph components; and mapping scores for the set of facial action units to a facial expression of the user during the sampling; transforming the facial expression of the user to an emotion of the user based on an emotion model.

### CROSS-REFERENCE TO RELATED APPLICATIONS

This Application claims the benefit of U.S. Provisional Application No. 62/548,686, filed on 22 Aug. 2017, which is incorporated in its entirety by this reference.

### TECHNICAL FIELD

This invention relates generally to the field of virtual reality and more specifically to a new and useful method for detecting facial expressions of users in the field of virtual reality.

### BRIEF DESCRIPTION OF THE FIGURES

FIG. 1 is a flow representation of a method;

FIGS. 2A and 2B are schematic representations of one variation of a system;

FIG. 3 is a flow representation of one variation of the method;

FIG. 4 is a schematic representation of one variation of the system; and

FIG. 5 is a schematic representation of one variation of the system.

### DESCRIPTION OF THE EMBODIMENTS

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

### 1. Method

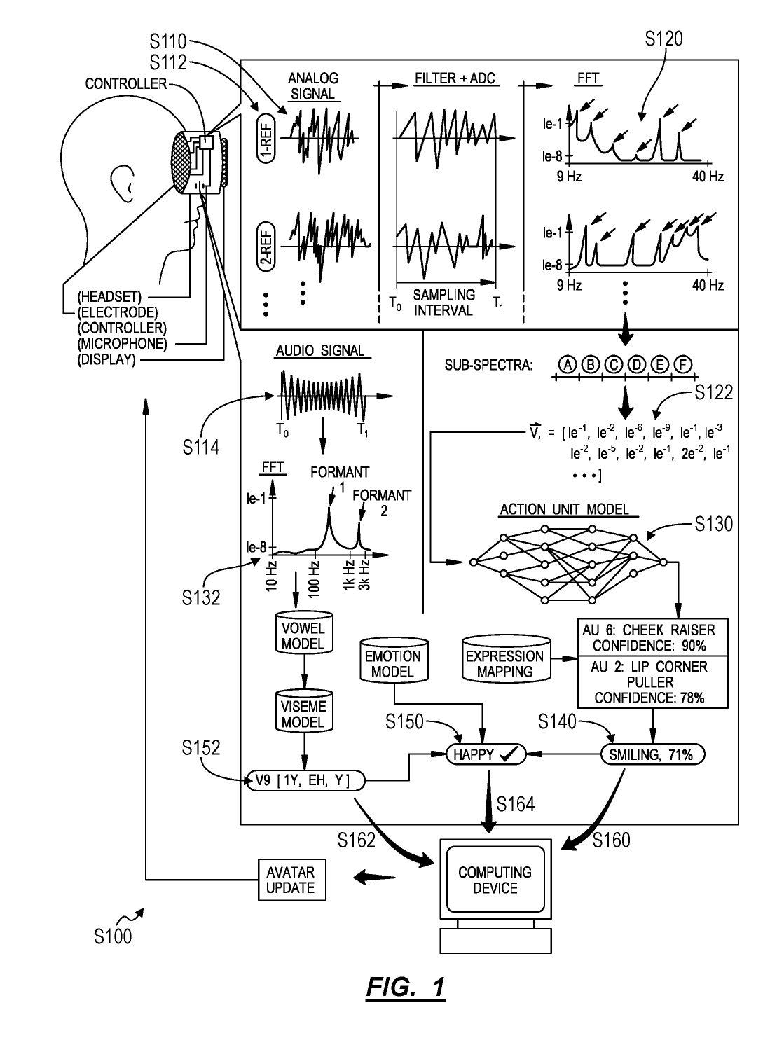

As shown in FIG. 1, a method for detecting emotions of users includes: during a sampling interval, recording a set of electromyograph signals through a set of sense electrodes arranged about a viewing window in a virtual reality headset worn by a user in Block S110; deducting a reference signal from each electromyograph signal in the set of electromyograph signals to generate a set of composite signals in Block S112; and for each composite signal in the set of composite signals, transforming the composite signal into a spectrum of oscillating electromyograph components within a frequency range of interest in Block S120. The method S100 also includes, for each facial action unit in a set of facial action units, calculating a score indicating presence of the facial action unit in the user's facial musculature during the sampling interval based on the spectrum of oscillating electromyograph components in Block S130; and mapping scores for the set of facial action units to a facial expression of the user during the sampling interval in Block S140; transforming the facial expression of the user to an emotion of the user based on an emotion model in Block S150; and outputting an identifier of the emotion to a device in Block S162, and optionally an identifier of the facial expression in Block S160.

One variation of the method S100 also includes: during the sampling interval, recording an audio signal in Block S114; transforming the audio signal into a spectrum of oscillating audio components in Block S132; calculating a mouth position of the user based on the spectrum of oscillating audio components in Block S152; and outputting an identifier of the facial expression and a viseme value representing the mouth position of the user during the sampling interval in Block S162.

### 2. Applications

Generally, the method S100 can be implemented by or in conjunction with a head-mounted display (or “headset”) worn by a user to: measure electrical activity of facial muscles through a set of sense electrodes arranged between the user's face and the head-mounted display during a sampling interval; to transform this electrical activity into one or more facial action units of the user's face or into a composite facial expression representing the greater area of the user's face. Additionally, the headset can implement the method S100 to integrate additional biological signals, such as galvanic skin response (hereinafter “GSR”), heartrate, and heartrate variability, with the user's composite facial expression to estimate an emotion of the user. Furthermore, the method S100 can be implemented to: collect an audio signal proximal the user during the sampling interval; to interpret this audio signal as a mouth shape (or “viseme”); and to output this facial expression and this mouth shape for implementation within a virtual environment.

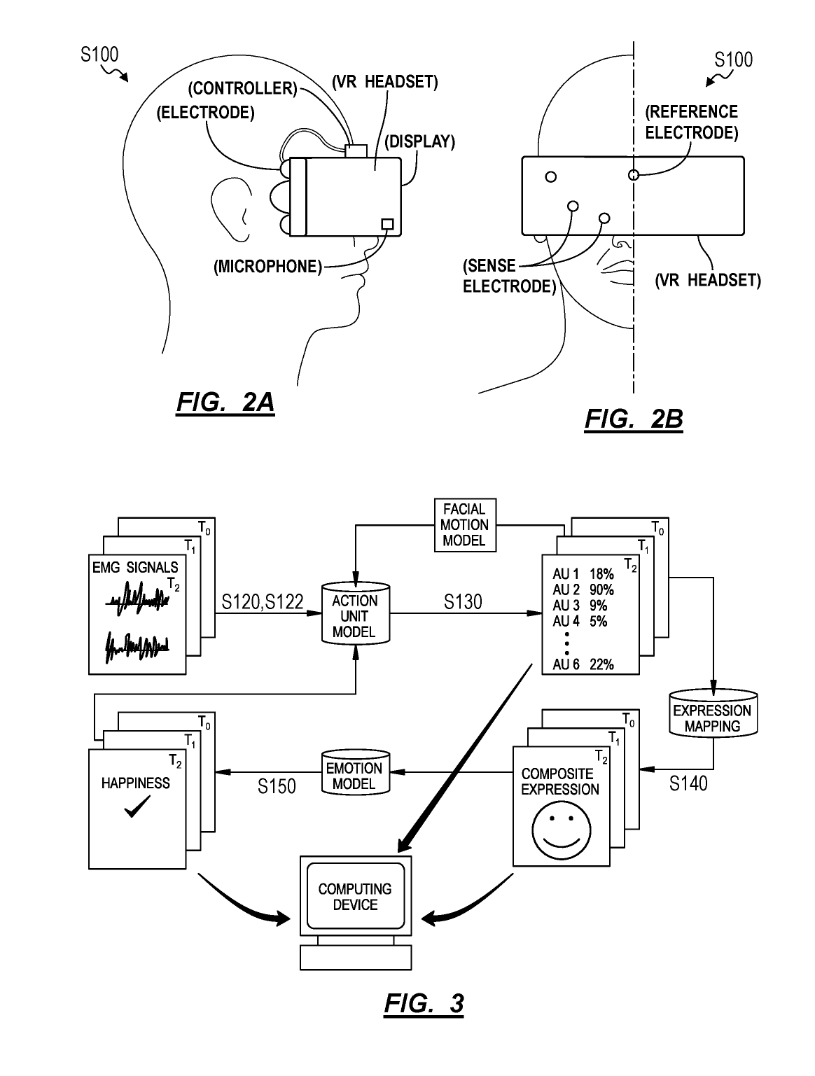

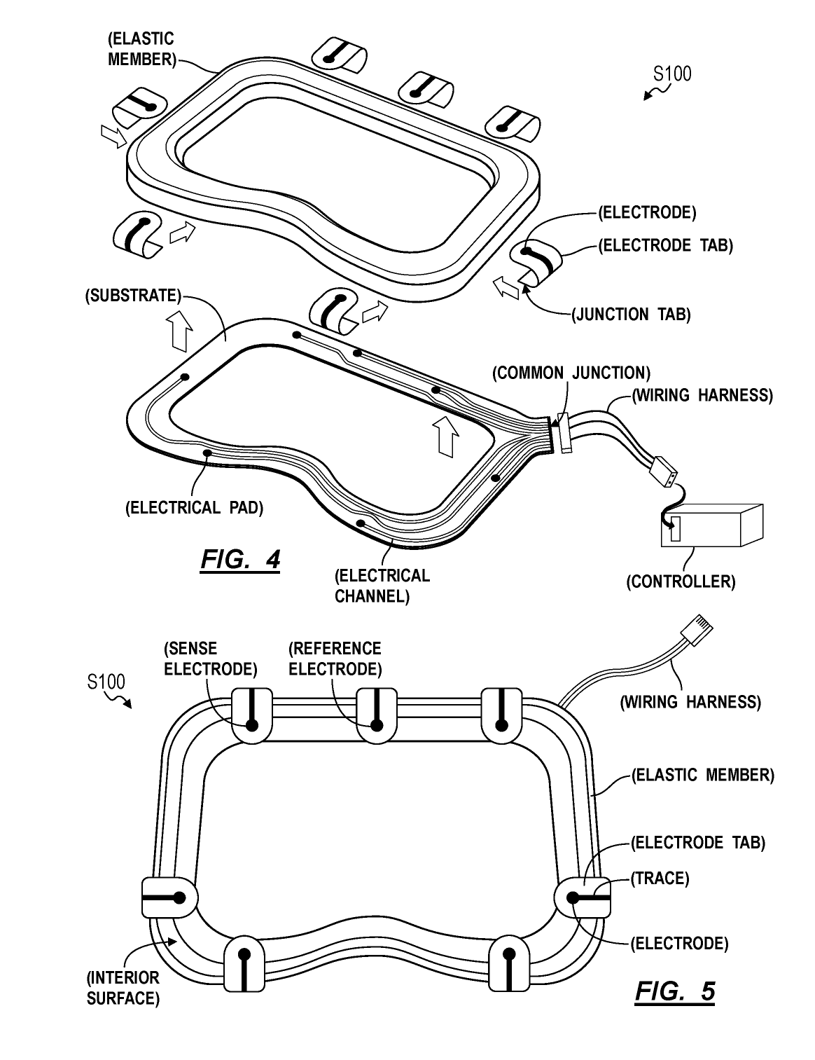

The method S100 can be implemented by a controller arranged or integrated into a virtual reality headset worn by a user, electrically coupled to a set of sense electrodes integrated into a gasket around a viewing window of the virtual reality headset, and electrically coupled to a microphone arranged on or in the virtual reality headset, as shown in FIGS. 2A, 2B, 4, and 5. The controller can thus implement the method to predict a set of facial action units and/or a composite facial expression of the user during a sampling interval and identify a viseme representative of the shape of the user's mouth during the sampling interval. The controller can then merge this facial expression with additional biometric signals to estimate an emotion for the user and output a set of identifiers representing the set of facial action units, the composite facial expression, the viseme, and/or the emotion to a game console, mobile computing device (e.g., a smartphone), or other computing device hosting a virtual environment viewed through the headset. Upon receipt of this command, the game console, mobile computing device, or computing device can then update the virtual face of a virtual avatar—such as representing the user—within the virtual environment to demonstrate this same facial expression and/or viseme. Additionally or alternatively, the game console can update a body position, facial details, or voice quality of the virtual avatar representing the user to depict the last facial action units, composite facial expression, viseme, and/or emotion received from the controller.

In particular, a headset worn by a user may obscure optical access to at least a portion of the user's face, such as the user's eyes, brow (e.g., lower forehead), and cheeks, as shown in FIGS. 2A and 2B. To detect a facial expression of the user while the headset is worn by the user, the controller can read electromyograph (or “EMG”) signals—indicative of muscle movements and therefore expressions or expression changes on the user's face—from sense electrodes in contact with target regions of the user's face during a sampling interval, as shown in FIGS. 1 and 3. The controller can then extract spectra of oscillatory components from these EMG signals and pass these new spectra into an expression engine (e.g., a long short-term memory recurrent neural network) to identify a facial expression—in a predefined set of modeled facial expressions—characterized by spectra of oscillatory components of EMG signals most similar to these new spectra.

The expression engine can include multiple models (e.g. neural networks or other classifiers) for identifying various levels of human expression based on spectra of the EMG signals detected during a sampling interval at the headset. The expression engine can include an action unit model that transforms the spectra of the EMG signals into a set of facial action units presented by the user during the sampling interval. Additionally, the expression engine can include a facial expression model that transforms facial action units detected by the action unit model into composite facial expressions. The expression engine can also include an emotion model that transforms the identified composite facial expression and other biometric signals into an estimated emotion of the user.

However, because the headset may place the sense electrodes around the user's eyes, brow, temples, and upper cheek: EMG signals collected by the controller may represent weaker correlation to shapes of the user's mouth. Therefore, the controller can also collect an audio signal and transform this audio signal into a prediction for a viseme representing the shape of the user's mouth during the same sampling interval, as shown in FIG. 1. By then merging this predicted viseme with facial action units or a facial expression predicted based on EMG signals collected through the sense electrodes, the controller can form a more complete representation of the user's total facial expression (e.g., from forehead to jaw and lower lip) and/or confirm the EMG-based facial expression according to the audio-based viseme.

The controller can then return a value for the user's facial expression (or the EMG-based facial expression and the audio-based viseme) to the game console or other computing device, as shown in FIG. 3, which can update a virtual avatar—representing the user within a virtual environment—to embody these expressions substantially in real-time. The controller can repeat this process during each successive sampling interval during operation of the headset (e.g., at a sampling rate of 300 Hz with overlapping sampling intervals 100 milliseconds in length) to achieve an authentic virtual representation of changes to the user's facial expression over time while interfacing with the virtual environment through the headset.

### 3. System

In one implementation shown in FIGS. 2A, 2B, 4 and 5, the controller interfaces with a headset that includes: a display; a gasket arranged about the perimeter of the display and configured to conform to a face of a user around the user's eyes when the headset is worn by the user; a set of sense electrodes (and a reference electrode) distributed about the gasket opposite the display and configured to output EMG sense signals representative of electrical activity in the user's facial musculature; a signal acquisition module configured to filter analog sense signals and to convert these analog sense signals into digital signals; a microphone; and a wired or wireless communication module configured to output facial expression and/or viseme identifiers to an internal or external computing device executing a virtual environment rendered on the headset.

For example, the headset can include four sense electrodes, including: a lower left sense electrode arranged at a left zygomaticus/left levator labii superioris muscle region of the elastic member (i.e., under the left eye); an upper left sense electrode arranged at a left upper orbicularis oculi muscle region of the elastic member (i.e., over the left eye); a lower right sense electrode arranged at a right zygomaticus/right levator labii superioris muscle region of the elastic member (i.e., under the right eye); and an upper right sense electrode arranged at a right upper orbicularis oculi muscle region of the elastic member (i.e., over the right eye). In this example, the headset can also include a single reference electrode arranged over a procerus muscle at the nasal bridge region of the elastic member.

In the foregoing example, the headset can further include: an outer left sense electrode arranged at a left outermost orbicularis oculi muscle region of the elastic member (i.e., to the left of the left eye); and an outer right sense electrode arranged at a right outermost orbicularis oculi muscle region of the elastic member (i.e., to the right of the right eye). The headset can also include: an upper-inner left sense electrode arranged over a left upper orbicularis oculi/procerus muscle junction region of the elastic member (i.e., over the left eye between the upper left sense electrode and the vertical centerline of the elastic member); and an upper-inner right sense electrode arranged over a right upper orbicularis oculi/procerus muscle junction region of the elastic member (i.e., over the right eye between the upper right sense electrode and the vertical centerline of the elastic member).

However, the headset can include any other number of sense and reference electrodes arranged in any other configuration over the elastic member. Furthermore, the headset can exclude a physical reference electrode, and the controller can instead calculate a virtual reference signal as a function of a combination (e.g., a linear combination, an average) of sense signals read from the set of sense electrodes.

### 3.1 Auxiliary Biometric Sensors

In one variation, the headset can include a set of auxiliary biometric sensors, such as a skin galvanometer, a heartrate sensor, and/or an internally-facing optical sensor. Generally, the controller can leverage outputs of these auxiliary biometric sensors and cross-reference concurrent EMG signals read from the headset in order to increase the accuracy of facial expressions and emotions detected by the controller in Blocks S140 and S150 described below. The auxiliary biometric sensors can be directly integrated within the hardware of the headset. Alternatively or additionally, the auxiliary biometric sensors can connect to the headset via a wireless protocol, such as Bluetooth or WiFi, or via a wired connection. In another implementation, the headset and the auxiliary biometric sensors are mutually connected to a gaming console or other computational device implementing the method S100.

In one implementation, the controller reads a user's galvanic skin response (hereinafter “GSR”) from sense electrodes in the headset. The heartrate sensor can detect a user's instantaneous heartrate or a user's heartrate variability over a longer interval. The internally-facing optical sensor can be arranged to detect a level of pupil dilation of the user, a pupil orientation of the user, and/or a level of flushing due to vasodilation in the capillaries of the user (e.g. if the optical sensor is viewing the surface of the user's skin instead of the user's eye).

The controller can sample the set of auxiliary biometric sensors to obtain timestamped biometric signals concurrent with EMG signals within a sampling interval. The controller can integrate the timestamped biometric signals with facial expressions derived from the EMG signals from the concurrent sampling interval to estimate an emotion of the user during the sampling interval, as described below.

### 4. Sense Signal Collection and Pre-Processing

Block S110 of the method recites, during a sampling interval, recording a set of electromyograph signals through a set of sense electrodes arranged about a viewing window in a virtual reality headset worn by a user; and Block S112 of the method recites deducting a reference signal from each electromyograph signal in the set of electromyograph signals to generate a set of composite signals.

In one implementation, in Blocks S110 and S112, the signal acquisition module (integrated into or arranged on the headset): reads multiple analog sensor signals from sense electrodes in the headset; reads an analog reference signal from a reference electrode in the headset (or reads a virtual reference signal calculated by the controller and output by a digital-to-analog converter); removes (e.g., subtracts) the analog reference signal from each analog sense signal to generate multiple composite analog sense signals with reduced ambient and common-mode noise; passes each composite analog sense signals through an analog pre-filter, such as a low-pass filter and a high-pass filter configured to pass frequencies within a spectrum of interest (e.g., between 9 Hz and 40 Hz) with minimal attenuation and to predominantly reject frequencies outside of this spectrum; and then returns these filtered composite analog sense signals to an analog-to-digital converter. The controller can then: read digital signals—corresponding to these filtered composite analog sense signals—from an analog-to-digital-converter, such as at a rate of 300 Hz; and pass these digital signals through a digital noise filter to (e.g., a low-pass Gaussian noise filter) to remove noise and preserve periodic signals within the spectrum of interest in each digital sense signal.

### 5. Signal Analysis

Block S120 of the method recites, for each composite signal in the set of composite signals, transforming the composite signal into a spectrum of oscillating EMG components within a frequency range of interest. Generally, in Block S120, the controller can transform (e.g., via Fast Fourier Transform) each digital sense time domain signal —recorded over a sampling interval of preset duration—into its constituent oscillatory components within the spectrum of interest and then compile representations of these oscillatory components across the set of sense signals into a (single) data structure representative of electrical activity of facial muscles across the user's face with the sampling interval.

In one implementation, for each of m-number of sense channels, the controller: samples the sense electrode at a rate of 1000 Hz (e.g., 1000 samples per second); and implements Fourier analysis to transform a digital signal—read from this sense channel over a 100-millisecond sampling interval (e.g., 100 samples)—into constituent oscillatory components (i.e., frequencies) within the spectrum of interest (e.g., from 9 Hz to 40 Hz) in Block S120, as shown in FIG. 1.

For each sense channel, the controller can then segment the spectrum of oscillatory components present in the sense signal into characteristic n-number of sub-spectra, such with: n=6 discrete (i.e., non-overlapping) sub-spectra, including 9-15 Hz, 15-20 Hz, 20-25 Hz, 25-30 Hz, 30-35 Hz, and 35-40 Hz; or n=31 discrete one-Hz-wide sub-spectra, or any other number and range of discrete or overlapping sub-spectra. For each sub-spectrum within one sense signal in the current sampling interval, the controller can integrate amplitude over frequencies represented in the sub-spectrum to calculate a magnitude value for the sub-spectrum. Alternatively, the controller can: extract an amplitude of a center frequency or a target frequency within the sub-spectrum and store this amplitude as a magnitude value for the sub-spectrum; determine a number of distinct frequencies of interest above a threshold amplitude represented in the sub-spectrum and store this number as a magnitude value for the sub-spectrum; or determine whether one or more frequencies of interest in the sub-spectrum is present and store either a “0” or “1” value as a magnitude value for the sub-spectrum accordingly. However, the controller can implement any other method or schema to calculate or generate a magnitude value representative of a sub-spectrum of a sense channel during the sampling interval. The controller can repeat this process for each sub-spectrum in each digital sense signal for the sampling interval.

In addition to frequency analysis techniques, the controller can implement wavelet analysis to analyze the digital EMG signals. In one implementation, the method S100 includes applying a wavelet transform to the digital EMG signals. Similar to the frequency analysis discussed above, the method S100 can separate a set of wavelet coefficients from a wavelet transform into discrete sub-spectra in order to obtain magnitude values in each sub-spectrum over the sampling interval. Thus, the method S100 can include a time-frequency analysis of the EMG signal to obtain magnitudes in each sub-spectrum as well as durations and/or timings corresponding to the sub-spectra in the EMG signal. For example, a sub-spectrum can be associated with a duration corresponding to the time for which the coherence of the sub-spectrum is above a threshold value in the digital EMG signal.

The controller can then compile discrete magnitude values representative of each sub-spectrum in each sense channel into a single data structure (e.g., an [m×n]-dimensional vector) according to a predefined paradigm, as shown in FIG. 1. For example, in Block S122, the controller can compile magnitude values of all sub-spectra for each digital sense signal within the sampling interval into a vector [A_{c1,s1}, A_{c1,s2}, A_{c1,s3}, . . . A_{c1,sn}, A_{c2,s1}, A_{c2,s2}, . . . , A_{c2,sn}, . . . , A_{cm,s1}, A_{cm,s2}, . . . , A_{cm,sn}], wherein: “cᵢ” represents the i^{th} sense channel in m sense channels; “cᵢsⱼ” represents the j^{th} sub-spectrum, in n sub-spectra, in the i^{th} sense channel; and “A_{cisj}” represents magnitude of the j^{th} sub-spectrum in the i^{th} sense channel. In one implementation, timing or duration information resulting from a wavelet or time-frequency analysis are included in the input vector as additional features.

The controller can then pass this vector through an expression engine —such as a neural network trained on similar vectors labeled with known human facial action units or facial expressions—to predict the facial action units or the composite facial expression of the user during the current sampling interval (or during the current sampling period within the current sampling interval) in Blocks S130 and S140 described below.

However, the controller can implement any other method or technique to transform multiple digital sense signals read during a sampling interval into one or more quantitative or qualitative data structures that can then be compared to a preexisting expression engine to determine the user's facial expression during the current sampling interval.

### 6. Expression Engine

The controller can thus implement a preexisting expression engine to transform a vector or other data structure generated from sense signals collected during the current sampling interval into prediction of the user's facial expression (e.g., a composite facial expression of multiple discrete facial action units) during this sampling interval. Generally, distinct facial action units may be the result of unique combinations of activity of facial muscles, which may be the result of a unique combination of electrical activity in muscles in the face, which may yield unique constellations of oscillatory components in sense signals read from each sense channel in a headset worn by users conveying these facial expressions over time.

In one implementation, the expression engine includes a set of component models, such as: an action unit model; an anatomical model; a facial motion model; an expression mapping model; and/or an emotion model.

### 6.1 Action Unit Model

Block S130 of the method S100 recites, for each facial action unit in a set of facial action units, calculating a score indicating presence of the facial action unit in the user's facial musculature during the sampling interval based on the spectrum of oscillating electromyograph components. In one implementation, the expression engine includes an action unit model which can perform Block S130 to detect the presence of facial action units, such as any of the facial action units of the Facial Action Coding System (hereinafter FACS). Facial action units of FACS include: neutral face, inner brow raiser, outer brow raiser, brow lowerer, upper lid raiser, cheek raiser, lid tightener, lips toward each other, nose wrinkler, upper lip raiser, nasolabial deepener, lip corner puller, sharp lip puller, dimpler, lip corner depressor, lower lip depressor, chin raiser, lip pucker, tongue show, lip stretcher, neck tightener, lip funneler, lip tightener, lip pressor, lips part, jaw drop, mouth stretch, lip suck, jaw thrust, jaw sideways, jaw clencher, lip bite, cheek blow, cheek puff, cheek suck, tongue bulge, lip wipe, nostril dilator, nostril compression, sniff, lid droop, slit, eyes closed, squint, blink, and wink. Additionally, the action unit model can detect whether any of the aforementioned facial action units are unilateral, right-sided, or left-sided. Furthermore, the action unit model can detect discrete intensity levels for each of the aforementioned action units, which can include: trace, slight, pronounced, severe, and maximum intensities. However, the action unit model can include any designation or number of discrete intensity levels.

An action unit model may therefore correlate various characteristics of a set of concurrent EMG signals—derived via signal analysis techniques described above—with contraction or extension of facial muscles. For example, a cheek raiser action unit may correspond with a contraction of the orbicularis oculi muscle. The action unit model can map indications of extension or contraction represented in EMG signals to a particular facial action unit based on the anatomical basis of the particular facial action in human musculature.

In one implementation, the action unit model detects facial action units that involve muscles on the upper part of the face, for example any of the facial action units that involve the zygomaticus major muscles or any of the muscles higher on the user facial musculature. In another implementation, the action unit model detects facial action units with a direct facial-muscular basis. For example, the action unit model can exclude the sniff action unit because it only involves the muscles in the chest causing inhalation and may not correlate with any facial muscle activation.

However, the action unit model can detect any other classification of atomic facial expressions similar to FACS facial action units based on detected correlations with EMG signal characteristics (i.e. the input vector generated in Block S122).

As shown in FIG. 1, the action unit model can include a neural network or other artificial intelligence trained on a set of data structures generated from sense signals read from sense electrodes in headsets worn by a population of users over time and labeled with facial action units, lateral presentation (i.e. unilateral, right-side, or left-sided), and/or discrete intensity levels of these action units at times that these sense signals were recorded (i.e., “labeled vectors”). For example, the controller can construct a labeled vector that: includes an [m×n]-dimensional vector, wherein each dimension in the vector contains a magnitude value representative of a corresponding sub-spectrum of a sense signal read from a sense electrode in a known position on a headset of the same or similar type during a sampling interval of the same or similar duration; and is labeled with a particular facial action unit—in a predefined set of facial action units—characteristic of a user wearing this headset during this sampling interval. A corpus of generic labeled vectors can thus be generated by collecting biometric data from similar sets of sense electrodes arranged in similar headsets worn by various users within a user population over time and labeled (manually) according to a variety of predefined facial action units of these users at times that these biometric data were collected.

This corpus of labeled vectors can be compiled and maintained on a remote computer system (e.g., a remote server and remote database). This remote computer system can also implement a support vector machine or other supervised learning model to perform non-linear classification on these labeled vectors, to separate classes of labeled vectors representing distinct facial action units, and to represent these classes in an action unit model (e.g., a long short-term memory recurrent neural network). This action unit model can be loaded onto the controller (or can be otherwise accessible to the controller) during operation of the headset, and the controller can pass a vector generated in Block S122 into the action unit model to determine a nearest (e.g., most representative) “class” of the vector and to predict a facial action unit characteristic of the user during the sampling interval based on the class of the vector.

In one implementation, in Block S130, the action unit model outputs a confidence level for each facial action unit in the set of predefined facial action units. In implementations that include facial location and/or discrete intensity levels for each of the predefined facial action units, the action unit model can output a confidence level for each facial location or discrete intensity level related to a facial action unit. For example, in Block S130 the action unit model can output a separate confidence level for a left-sided wink and for a right-sided wink and/or a separate confidence level for a pronounced brow lowerer and for a trace brow lowerer.

The action unit model can output a raw confidence level value (e.g. [0, 1] or as a percentage) for each of the predefined action units as an array or any applicable data structure. For example, the action unit model can output confidence scores for each of the predefined facial action units according to the likelihood of presence of each facial action unit on the face of the user within the sampling interval. Alternatively, in Block S130 the action unit model can include a confidence level threshold, wherein the action unit model outputs identifiers indicating facial action units that have confidence levels greater than the confidence level threshold. For example, for a preset confidence level threshold of 0.90, if the action unit model calculates confidence levels greater than 0.90 for the left-sided wink and the right-sided inner brow raiser only, the action unit model can then output identifiers representing a left-sided wink and a right-sided inner brow raiser in Block S130.

However, the action unit model can implement any other machine learning or statistical technique to transform EMG signals from a headset worn by a user into facial action units present in the facial musculature of the user.

### 6.2 Anatomical Model

In one implementation, the expression engine can include an anatomical model of the human face, which leverages human anatomy to bound the classification of facial action units in Block S130. Thus, the method S100 leverages human anatomy to improve the accuracy of expression detection.

The anatomical model can include a series of logical statements applied to the output of the action unit model representing the anatomical limitations of the human face. In one implementation, the anatomical model constrains the action unit model, such that it does not output identifiers indicating the presence of the same facial action unit at two discrete intensity levels. To accomplish this the anatomical model removes the identifiers of the discrete intensity levels with lower confidence levels.

In one implementation, the anatomical model filters the output of the action unit model according to anatomically based and predefined sets of mutually exclusive facial action units. A set of mutually exclusive facial action units can include facial action units that utilize the same muscle performing an opposite action (e.g. extension and contraction). For example, the lip funneler, lip tightener, and lip pressor action units are mutually exclusive because they all have an anatomical basis of the orbicularis oris muscle, which cannot perform more than one of the three action units within a short sampling interval. Alternatively, a set of mutually exclusive facial action units can include facial action units that are performed using different muscles but that pull facial tissue in opposite or anatomically impossible directions. For example, a brow lowerer and a brow raiser in the same facial location are performed using different muscles but both pull the brow in opposite directions.

In one implementation, the anatomical model removes all but one of the facial action units in a set of mutually exclusive facial action units outputted by the action unit model, keeping only the facial action unit identifier with the largest confidence level. In another implementation, the anatomical model alters the confidence levels of the action unit model based on the mutually exclusive sets of facial action units.

Additionally or alternatively, the anatomical model can include sets of incompatible facial action units, which, although not mutually exclusive, may be difficult to perform within one sampling interval for most users or, alternatively, may be an uncommon facial expression. In this implementation, the anatomical model can adjust the relative confidence levels associated with the sets of incompatible facial action units in the action unit model. For example, it may be difficult or unusual for an average user to express both a mouth stretch and a squint facial action unit. Thus, if both of these facial action units are detected by the action unit model then the anatomical model can increase or decrease the confidence levels associated with one or both of the facial action units based on their relative associated confidence levels.

In implementations in which the controller incorporates audio signal analysis and the detection of visemes, the anatomical model can include relationships between particular visemes and facial action units that can be detected by the action unit model. The anatomical model can adjust confidence levels for visemes according to conflicting facial anatomy between a detected viseme and a detected facial action unit. This crosschecking process is further described below.

However, the anatomical model can be implemented in any manner that further limits the output of the action unit model according to an anatomical understanding of the human face.

### 6.3 Facial Motion Model

In one implementation, the expression engine can include a facial motion model. Generally, the facial motion model leverages recently detected facial action units to constrain the action unit model within physically plausible bounds. Depending on the length of each sampling interval it may be physically impossible for a user to have expressed a vastly anatomically different facial action unit. The facial motion model defines a set of temporally incoherent facial action units with a low likelihood of being expressed in a subsequent sampling interval given the action units detected in a previous sampling interval. More specifically, the facial motion model can define a set of rules, weights, etc. that constrain possible action units output by the action unit model during consecutive sampling intervals based on anatomical limitations of human facial movement. For example, if the sampling interval is a thirtieth of a second (i.e. 33 milliseconds), and the action unit model has detected an eyes closed facial action unit present within the previous sampling interval, then the facial motion model can be applied to the output of the action unit model to increase the confidence level associated with the slit, lid droop, and squint facial action units, while decreasing the confidence level associated with an eyes open facial action unit based on anatomical knowledge that the eye takes longer than the sampling interval (e.g. 150-200 millseconds) to open completely.

In one implementation, the facial motion model includes a predefined set of weights over the entire space of detectable facial action units, wherein each set of weights corresponds to a single facial action unit in a previous sampling interval. In this implementation, if multiple facial action units are detected in a previous sampling interval the facial motion model can multiply weights corresponding to each previously detected facial action unit to determine weighting for the subsequent sampling interval. These weights can be defined by performing statistical analysis on previous facial expression data to determine the distribution of transition times between each pair of facial action units.

However, the facial motion model can modify the outputs of the action unit model in any way to represent the transitional characteristics of the human face.

### 6.4 Action Unit Probability Based on Emotional State

In one implementation, the action unit model can incorporate an estimated emotional state of the user into the aforementioned feature vector of Block S122. The estimated emotional state can be determined in a previous sampling interval by the emotion model described in further detail below. For example, if the emotion model detected that the user expressed a “sad” emotional state during a preceding sampling interval, the action unit model can reduce the confidence level of action units corresponding to smiles or other expressions during the current sampling interval. Therefore, the action unit model can leverage an emotional state of a user derived during a previous sampling interval to inform the detection of action units during a current sampling interval.

### 6.5 Expression Mapping

Block S140 of the method S100 recites mapping scores for the set of facial action units to a facial expression of the user during the sampling interval. The expression engine can additionally or alternatively represent composite facial expressions, such as defined by a combination of facial action units, including: relaxed (e.g., relaxed brow, eyes, cheeks, and mouth); confusion; shame (e.g., eyebrows arch outwardly, mouth droops); surprise (e.g., eyebrows raised and curved central to the forehead, eyelids open with upper lids are raised and lower lids lowered, jaw dropped with lips and teeth parted); focus (e.g., brow lowered with resting cheeks and resting mouth); exhaustion; anger (e.g., eyes narrowed with eyebrows angled down, lips tightened, and cheeks tensioned); fear; sadness; and happiness (e.g., squinting in brow and eyes with cheeks raised and corners of mouth raised); etc. Furthermore, the expression mapping can represent intensity levels of these composite facial expressions. For example, in Block S140, the expression mapping can compile facial action units into a singular composite facial expression based on types and intensity levels of the facial action units detected. The controller can thus output an identifier of a singular expression for the current sampling interval in Block S160 based on the expression mapping and the facial action units identified by the action unit model.

In one implementation, the expression mapping is a direct mapping between component facial action units and composite facial expressions. Depending on the application of the method S100, the expression mapping can output a single composite expression at a high sensitivity to component facial action units. For example, the expression mapping can define an equal or greater number of composite expressions than facial action units based on a set of predefined facial action units. Alternatively, the expression mapping can effectively “down sample” the predefined set of facial action units into a smaller number of composite expressions. In this case, the expression mapping can relate multiple combinations of component facial action units to the same composite expression. The expression mapping can take as input only action units with a confidence level over a threshold confidence level.

The expression mapping may also take the set of confidence levels associated with each component facial action unit as input to determine a resulting composite facial expression. Additionally or alternatively, the expression mapping can output a confidence level of the composite facial expression based on confidence levels of the set of input facial action units.

In one implementation, the expression mapping can output composite facial expressions for one sub-region of the face in Block S140. For example, the expression mapping can only output identifiers for facial expressions that include the upper half of the face. Additionally or alternatively, regions of the face included in a composite expression can also be conditional on any visemes detected using a viseme model.

### 6.6 Emotion Model

Block S150 of the method S100 recites transforming the facial expression of the user to an emotion of the user based on an emotion model. In one implementation, the expression engine includes an emotion model. Generally, the emotion model estimates the emotional state of the user via biometric sensor fusion. The emotion model can utilize expression identifiers generated by the expression mapping, facial action unit identifiers generated by the action unit model, and auxiliary biometric signals to estimate the emotional state of a user. The emotion model can be executed at the headset in series with the action unit model, and the expression mapping. Alternatively, the emotion model is implemented at a gaming console or other processor connected to the headset.

The emotion model can take various biometric data and expression data as input to generate a representative feature vector. The emotion model can then perform any suitable classification algorithm to estimate the emotional state of the user based on the feature vector. For example, the emotion model can incorporate an expression from the expression mapping, GSR data, heartrate data, and heartrate variability data to estimate an emotional state of the user. The emotion model can output an identifier of the estimated emotional state of the user from a predefined set of emotional states, such as fear, anger, sadness, joy, disgust, surprise, anticipation etc. The predefined set of emotional states can vary based on the application of the emotion model.

The emotion model can estimate the emotional state of a user once per sampling interval or at a lower frequency since broad changes in emotional state may occur less frequently than changes in expression.

However, the emotion model can integrate expression data with biometric data to estimate an emotional state of the user in any other way.

### 7. Calibration

In one variation, the controller interfaces with an external native application, game console, or other computing device hosting the virtual environment—rendered on the display of the headset—to execute a calibration routine to calibrate the expression engine to the user. In one implementation: the controller synchronizes with the computing device; the computing device actively serves instructions to the user to emulate a facial expression, such as by rendering a sequence of prompts to rest her face, smile, frown, look surprised, look angry, look focused, etc. on the display of the headset when the user first dons the headset and before beginning a game or opening a virtual environment within a game or other virtual experience. As the computing device serves these prompts to the user, the controller can implement Blocks S110, S112, S120, and S122 to generate a sequence of vectors representative of sense data collected during each sampling interval (e.g., one vector per 100-millisecond period), timestamp these vectors, and return these vectors to the computing device. The computing device can then selectively label these vectors with expressions or component facial action units instructed by the computing device at corresponding times.

In another implementation, the computing device indirectly prompts the user to produce a facial expression, such as by: rendering a joke on the display of the headset to produce a smile or happiness “expression” in the user; rendering a game instruction on the display in small font to produce a “focus” expression in the user; or rendering a sad anecdote on the display to produce a “sadness” expression in the user. As in the foregoing implementation, the controller can: synchronize with the computing device; implement Blocks S110, S112, S120, and S122 to generate a sequence of vectors representative of sense data collected over a series of sampling intervals; timestamp these vectors; and return these vectors to the computing device. The computing device can then selectively label these vectors with emotions based on expected facial expressions associated with indirect prompts served to the user at corresponding times.

Once such user-specific labeled vectors are thus generated, the computing device (or the remote computer system or the controller) can add these user-specific labeled vectors to the corpus of generic labeled vectors and retrain the expression engine on this extended corpus, such as with greater weight applied to the user-specific labeled vectors, thereby generating a custom expression engine “calibrated” specifically to the user. The computing device (or the remote computer system or the controller) can then associate this custom expression engine with the user (e.g., with the user's avatar or game profile), and the headset can implement this custom expression engine when the user is logged into the computing device and interfacing with the virtual environment through the headset.

Alternatively, the computing device can perform a cluster analysis of the sequence of vectors to relate the current user's vector with vectors of previous users (e.g. a k-means cluster analysis for each emotion expressed in the calibration process). The computing device can then retrain a cluster specific expression engine on the vectors identified within the current user's cluster to create a cluster-specific expression engine for the current user. This approach leverages the idea that there are multiple distinct categories of sense signals generated from various users and that developing a model for interpreting each user category can provide better accuracy than a broader model.

The controller, computing device, and/or remote computer system can repeat this process over time, such as each time the user dons the headset and logs in to the game or virtual environment in order to refine and customize the expression engine uniquely for the user over time.

### 8. Setup+Calibration

The controller, computing device, and/or remote computer system can additionally or alternatively select one of a set of predefined expression engines for the user, such as based on certain characteristics or demographics of the user, such as: head size (e.g., small, medium, large) and shape (e.g., long, rectangular, round); size and shape of special facial features (e.g., eyebrow, nose, cheeks, mouth); age; and/or gender; etc. For example, the computing device can: prompt user to construct—within a virtual environment—an avatar that best resembles the user's face; extract sizes and shapes of the user's facial features and other relevant characteristics of the user from this user-generated avatar; select a nearest expression engine, from the set of predefined expression engines, based on these characteristics of the user; and upload this expression engine to the headset for implementation by the controller in Block S140.

The controller, computing device, and/or remote computer system can then implement the foregoing methods and techniques to further refine this expression engine based on additional EMG data collected from the user during a calibration routine.

### 9. Expression Prediction

Block S140 of the method S100 recites predicting a facial expression of the user during the sampling interval based on an expression engine and magnitude values of sub-spectra for each composite signal in the set of composite signals. Generally, in Block S140, the controller passes the data structure generated in Block S122 into the expression engine to predict a set of facial action units, a set of facial action units and associated confidence levels, or a composite facial expression (and intensity levels thereof) exhibited on the user's face during the current sampling interval or current sampling period.

In one implementation in which the expression engine represents composite facial expressions, the controller implements a k-nearest neighbor classifier to identify a single class of composite facial expression—represented in the expression engine—nearest the vector generated in Block S122. Therefore, for the expression engine that defines clusters of known composite facial expressions, the controller can output a single composite facial expression represented by a cluster of labeled vectors nearest the vector generated in Block S122 for the current sampling interval. The controller can also calculate a confidence score for this predicted facial expression based on a distance from this new vector to (the centroid of) the nearest cluster of labeled vectors representing this facial expression.

In another implementation in which the expression engine defines clusters of known facial action units of various facial regions, the controller can implement similar methods to transform the new vector generated in Block S122 into a set of atomic expressions represented by clusters of labeled vectors nearest the new vector based on the expression engine. Similarly, the controller can: implement multiple distinct expression engines, such as unique to different regions of the face; generate one unique vector for each of these expression engines per sampling interval in Block S122; and pass these unique vectors into their corresponding expression engines to generate a list of predicted facial action units exhibited by the user during the current sampling interval in Block S140. The controller can then output this set of facial action units in Block S160. Alternatively, in this implementation, the controller can implement the expression mapping to combine a set of facial action units into one composite facial expression, as shown in FIG. 1, and then output this composite facial expression in Block S150.

### 10. Audio

As shown in FIG. 1, one variation of the method further includes: Block S114, which recites recording an audio signal during the sampling interval; Block S132, which recites decomposing the audio signal into a spectrum of oscillating audio components; and Block S152, which recites predicting a mouth position of the user based on amplitudes of oscillating audio components in the spectrum of oscillating audio components. Generally, in Block S114, S132, and S152, the controller can implement methods similar to those described above to: read an audio signal; decompose this audio signal into its constituent oscillatory components; and predict a shape of the user's mouth based on presence and/or amplitude of these oscillatory components. The controller can then merge this mouth shape with a facial expression predicted in Block S140 for the same sampling interval to generate a more complete “picture” of the user's face from forehead to chin during this sampling interval.

In Block S114, the controller can sample an analog-to-digital converter coupled to a microphone integrated into the headset, such as at a rate of 48 kHz, and implement noise cancelling or other pre-processing techniques to prepare this digital audio signal for analysis in Blocks S132 and S152.

In one implementation, the controller estimates a degree to which the user's mouth is open as a function of (e.g., proportional to) an amplitude (i.e., “loudness”) of the audio signal during this sampling interval. For example, the controller can implement an envelope follower to track the maximum amplitude of the digital audio signal and then correlate a magnitude output by the envelope follower with a degree to which the user's mouth is open during this sampling interval in Block S152. Similarly, if the amplitude of the audio signal is null or near null during the current sampling interval, the controller can predict that the user is not currently speaking in Block S152.

The controller can additionally or alternatively implement more sophisticated schema to predict vowels (e.g., “oh,” “ah,” etc.) spoken by the user during a sampling interval and to correlate these vowels with various representative mouth shapes. In one implementation, the controller: implements Fourier analysis to decompose the digital audio signal over the current sampling interval (e.g., 100 milliseconds) into its constituent oscillatory components; identifies a subset of these oscillatory components exhibiting resonance of spectral maxima (e.g., highest amplitudes); matches frequencies of this subset of oscillatory components with a set of vowel formants—such as defined in a lookup table or other model—representative of a predefined set of vowels; and predicts a vowel spoken by the user during the sampling interval based on these vowel formants. For example, the lookup table or other model can link: a first formant at 240 Hz and second formant at 2400 Hz (or a difference of 2160 Hz between spectral maximum frequencies in the audio signal) to the vowel “i”; a first formant at 235 Hz and second formant at 2100 Hz (or a difference of 1865 Hz between spectral maximum frequencies in the audio signal) to the vowel “y”; a first formant at 390 Hz and second formant at 2300 Hz (or a difference of 1910 Hz between spectral maximum frequencies in the audio signal) to the vowel “e”; and a first formant at 370 Hz and second formant at 1900 Hz (or a difference of 1530 Hz between spectral maximum frequencies in the audio signal) to the vowel “ø”; etc. Thus, if the controller detects both vowel formats linked to a particular vowel (within a preset tolerance), the controller can predict that the user is speaking this particular vowel during the current sampling interval. The controller can additionally or alternatively calculate a difference between the two spectral maximum frequencies of the oscillatory components and match this difference to a known frequency difference between first and second formants of a particular vowel.

The controller can implement similar methods and techniques to detect consonants spoken by the user during the current sampling interval, such as based on proximity of spectral maximum frequencies of oscillatory components in the audio signal to two or more formants representative of these consonants, in Block S132.

Once the controller has identified a particular vowel (or a particular consonant) spoken by the user during the current sampling interval, the controller can implement a lookup table or other model to identify a particular viseme (i.e., a visual equivalent of a phoneme or unit of sound in spoken language) associated with this particular vowel (or particular consonant).

In another implementation, the controller can pass a data structure representative of the audio signal during the current sampling interval (e.g., presence or amplitude of spectral maximum oscillatory components of the audio signal, such as described above) into a statistical Markov model or other dynamic Bayesian network, which can output an identifier of one of a predefined set of visemes most representative of the audio signal recorded during the current sampling interval. However, the controller can implement any other method or technique to predict a shape of the user's mouth during the current sampling interval (or current sampling period) based on this audio signal.

The controller can also pair the viseme identified during the current sampling interval with the predicted magnitude that the user's mouth is open during this sampling interval to yield an even more complete representation of the shape of the user's mouth and jaw during this sampling interval in Block S152.

In one implementation, the controller can merge the output viseme identified during the current sampling interval as a feature for the action unit model or expression mapping. Alternatively or additionally, the identified viseme can be fed back into the anatomical model or the facial motion model, such that the outputs of the action unit model are bounded by the identified viseme.

### 11. Output

Variations of the method S100 recite outputting identifier(s) of the set of facial action units presented by the user, an identifier of the composite facial expression, an identifier of the estimated emotion of a user, and/or an identifier of a viseme value representing the mouth during the sampling interval for application to a virtual face of an avatar within a virtual environment. Generally, in Blocks S160, S162, and S164, the controller can output a specification (e.g., identifiers) of the facial action units determined in Block S130, the composite facial expression determined in Block S140, and/or emotion determined in Block S150 and the viseme and mouth open magnitude determined in Block S152 substantially in real-time to the computing device executing the game or virtual environment. The computing device can then update a virtual avatar within the virtual environment to reflect this facial expression, viseme, and mouth open magnitude substantially in real-time, thereby approximating the user's real facial expression within the virtual environment and improving secondary modes of communication from the user to other users viewing the user's virtual avatar within the virtual environment.

### 11.1 Facial Expression Check

In one variation, the controller can also confirm or correct the composite facial expression and/or low-face atomic expression determined in Block S130 based on the viseme and/or mouth open magnitude determined in Block S152. In one implementation, if the controller determines that the user is not currently speaking (or predicts a viseme with a relatively low confidence) in Block S152, the controller can output an identifier of the composite facial expression determined in Block S140 and output a “null” value for a position of the mouth during the current time interval; the computing device can then update the virtual avatar of the user within the virtual environment based on the composite facial expression. However, if the controller detects that the user is speaking during the current sampling interval and determines a corresponding viseme (with a suitable degree of confidence), the controller can output an identifier of the composite facial expression with an override command for the mouth region including the viseme and the magnitude of the mouth opening; the computing device can then update the upper and middle regions of the face of the virtual avatar based on the composite facial expression update to the lower region of the face of the virtual avatar based on the viseme and magnitude.

In a similar implementation, the controller can output distinct facial action units for various regions of the face (e.g., brow, eyes, upper cheeks, mouth, and jaw) and then compile these distinct atomic expressions into a single composite facial expression in Block S140, such as based on the expression mapping, before outputting this composite facial expression in Block S150. In this implementation, when speech by the user is detected and a viseme determined for the current sampling interval in Block S152, the controller can: output facial action units in Block S130; and apply a reduced weight to a facial action unit determined for the mouth region and apply increased weight to the viseme when passing these disparate facial action units into the expression mapping.

In another implementation, the controller implements: an expression paradigm further including a dimension for the viseme (and magnitude of mouth opening) when generating a vector for the current time interval in Block S122; and an expression engine trained on a corpus of labeled vectors, including vectors labeled with facial expressions and no speech (or “speechless expression”) and other vectors labeled with facial expressions and a particular viseme (or “speaking expression”) in Block S130. In this implementation, if the controller determines that the user is not currently speaking (or predicts a viseme with a relatively low confidence) in Block S152, the controller can: implement foregoing methods and techniques to generate a vector representing sense signals read from the sense electrodes during the current time interval; insert a null value into the viseme dimension of the vector; pass the vector through the expression engine to detect a speechless expression for the current time interval in Block S140; and output this speechless expression to the computing device in Block S160. However, if the controller detects that the user is speaking during the current sampling interval and determines a corresponding viseme (with a suitable degree of confidence) in Block S152, the controller can: write a value representing the identified viseme to the corresponding dimension in the vector; implement the foregoing methods and techniques to populate the vector with values representing sense signals read from the sense electrodes; and pass the vector through the expression engine to detect a speaking expression, such as including eyebrow, eye, upper cheek, and mouth positions, in Block S140. The controller can thus predict the user's complete facial expression based on both sense signals read from sense electrodes arranged about the user's brow, temples, and upper cheeks and based on a viseme determined from an audio signal read during a sampling interval.

In a similar implementation, the controller can: implement a speechless expression engine configured to output facial expressions based on [m×n]-dimensional vectors excluding viseme values in Block S130 when no speech by the user is detected in Block S152; and implement a speech-informed expression engine configured to output facial expressions based on [m×n+1]-dimensional vectors including a viseme value in Block S130 when speech by the user is detected in Block S152.

However, the controller can implement any other method or technique to confirm alignment between a facial expression determined from sense signals in Block S130 and a viseme determined from an audio signal in Block S152, to modify one or both of these determinations based on misalignment, or to otherwise merge these determinations before outputting discrete facial action units and visemes or a single composite facial expression to the computing device in Blocks S160, S162, and/or S164.

### 11.2 Repetition

The controller can repeat this process over time to generate and output discrete atomic facial expressions and visemes or singular composite facial expressions, such as at a rate of once per sampling interval (e.g., at a rate of 10 Hz) or once per sampling period (e.g., at a rate of 300 Hz). The computing device can then implement these outputs of the controller to regularly update a virtual facial expression of a virtual avatar within a virtual environment rendered on the headset worn by the user and/or rendered on another headset worn by another user viewing the virtual environment. The computing device can also implement outputs of the emotion model to regularly update a visual indication of the emotional state of the user of the virtual avatar, such as a slight modification to the facial expression of the virtual avatar (e.g. modifying a generic or happy smile to a frustrated smile).

### 12. Content Integration

In one implementation, the game console or controller records outputs of the method S100 in association with particular virtual content displayed to the user within the sampling interval for the output. For example, the emotional state, composite expression, or set of facial action units detected from the face of the user can be recorded by the computational device or game console in association with a timestamp, which can then be aligned with content, generated by the computational device, that was displayed to the user via the headset. Alternatively, an audio video clip of the content displayed to the user via the headset can be recorded directly in association with the outputs of the method S100. In yet another implementation, game input commands issued by the user during the sampling interval can be recorded in associated with the outputs of the method S100.

The systems and methods described herein can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

I claim:

1. A method for detecting a facial expression of a user comprises:
during a sampling interval, recording a set of electromyograph signals through a set of sense electrodes arranged about a viewing window in a virtual reality headset worn by a user;
deducting a reference signal from each electromyograph signal in the set of electromyograph signals to generate a set of composite signals;
for each composite signal in the set of composite signals, transforming the composite signal into a spectrum of oscillating electromyograph components within a frequency range of interest;
for each facial action unit in a set of facial action units, calculating a score indicating presence of the facial action unit in the user's facial musculature during the sampling interval based on the spectrum of oscillating electromyograph components; and
mapping scores for the set of facial action units to a facial expression of the user during the sampling interval;
transforming the facial expression of the user to an emotion of the user based on an emotion model; and
outputting an identifier of the emotion to a device.

2. The method of claim 1:
wherein, for each facial action unit in the set of facial action units, calculating a score indicating presence of the facial action unit further comprises, for each facial action unit in the set of facial action units:
calculating a confidence level associated with the facial action unit that the user presented the facial action unit during the sampling interval based on a facial action unit model and the spectrum of oscillating electromyograph components; and
in response to the confidence level associated with the facial action unit exceeding a confidence threshold, identifying the facial action unit as a component facial action unit in a set of component facial action units;
wherein mapping scores for the set of facial action units to a facial expression of the user during the sampling interval further comprises, mapping the set of component facial action units to the facial expression of the user during the sampling interval.

3. The method of claim 2, further comprising:
identifying in the set of component facial action units a set of mutually exclusive facial action units based on an anatomical model;
identifying in the set of mutually exclusive facial action units the facial action unit associated with a maximum confidence level; and
removing the set of mutually exclusive facial action units from the set of component facial action units with the exception of the facial action unit associated with the maximum confidence level.

4. The method of claim 1, further comprising:
accessing a previous set of component facial action units identified during a previous sampling interval;
identifying a set of temporally incoherent facial action units based on the previous set of component facial action units, a time elapsed between the previous sampling interval and the sampling interval, and a facial motion model; and
removing, from the set of facial action units, the set of temporally incoherent facial action units.

5. The method of claim 1:
wherein each facial action unit in the set of facial action units comprises a set of discrete intensity levels of the facial action unit;
wherein, for each facial action unit in the set of facial action units, calculating a score indicating presence of the facial action unit further comprises, for each facial action unit in the set of facial action units:
for each discrete intensity level in the set of discrete intensity levels of the facial action unit:
calculating a confidence level associated with the facial action unit and the discrete intensity level that the user presented the facial action unit at the discrete intensity level during the sampling interval based on the facial action unit model and the spectrum of oscillating electromyograph components; and
in response to the confidence level associated with the facial action unit and the discrete intensity level exceeding the confidence threshold, identifying the facial action unit at the discrete intensity level as a component facial action unit in a set of component facial action units; and
wherein mapping scores for the set of facial action units to a facial expression of the user during the sampling interval further comprises, mapping the set of component facial action units to the facial expression of the user during the sampling interval.

6. The method of claim 1:
further comprising, during the sampling interval:
recording a galvanic skin response of the user through the set of sense electrodes;
recording a heartrate of the user through a heartrate monitor; and
recording a heartrate variability of the user through the heartrate monitor; and
wherein outputting the identifier of the emotion of the user further comprises, outputting the identifier of the emotion of the user based on the emotion model, the facial expression of the user, the galvanic skin response of the user, the heartrate of the user, and the heartrate variability of the user.

7. The method of claim 1, wherein outputting the identifier of the emotion of the user further comprises, outputting the identifier of the emotion of the user and an identifier of the expression of the user.

8. The method of claim 1, further comprising:
responsive to detecting a change between a previous identifier of an emotion of the user and the identifier of the emotion of the user during the sampling interval; and
recording content displayed on the viewing window of the virtual reality headset during the sampling interval.

9. A method for detecting a facial expression of a user comprises:
during a sampling interval, recording a set of electromyograph signals through a set of sense electrodes arranged about a viewing window in a virtual reality headset worn by a user;
deducting a reference signal from each electromyograph signal in the set of electromyograph signals to generate a set of composite signals;
for each composite signal in the set of composite signals, transforming the composite signal into a spectrum of oscillating electromyograph components within a frequency range of interest;
for each facial action unit in a set of facial action units:
calculating a confidence level associated with the facial action unit, based on the spectrum of oscillating electromyograph components; and
in response to the confidence level associated with the facial action unit exceeding a confidence threshold, identifying the facial action unit as a component facial action unit in a set of component facial action units;
mapping the set of component facial action units to a facial expression of the user during the sampling interval;
outputting an identifier of the facial expression of the user to a device.

10. The method of claim 9, further comprising:
during the sampling interval, recording an audio signal;
transforming the audio signal into a spectrum of oscillating audio components;
calculating a mouth position of the user based on the spectrum of oscillating audio components; and
outputting an identifier of the facial expression and a viseme value representing the mouth position of the user during the sampling interval to the device.

11. The method of claim 10, wherein outputting an identifier of the facial expression and the viseme value representing the mouth position further comprises, outputting an identifier for each of the set of component facial action units.

12. The method of claim 10, wherein for each facial action unit in the set of facial action units, calculating a confidence level associated with the facial action unit, based on the spectrum of oscillating electromyograph components, further comprises:
for each facial action unit in the set of facial action units, calculating the confidence level associated with the facial action unit, based on the spectrum of oscillating electromyograph components, the mouth position of the user, and an anatomical model.

13. The method of claim 9, further comprising:
during the sampling interval, recording a video of the lower face of the user;
identifying a mouth position of the user based on the video of the lower face of the user; and
outputting an identifier of the facial expression and a viseme value representing the mouth position of the user during the sampling interval.

14. The method of claim 9, wherein calculating a confidence level associated with the facial action unit further comprises:
accessing a previous facial expression of the user identified during a previous sampling interval;
identifying a set of temporally incoherent facial action units based on the previous facial expression, a time elapsed between the previous sampling interval and the sampling interval, and a facial motion model; and
removing, from the set of facial action units, the set of temporally incoherent facial action units.

15. A method for detecting a facial expression of a user comprises:
during a sampling interval, recording a set of electromyograph signals through a set of sense electrodes arranged about a viewing window in a virtual reality headset worn by a user;
deducting a reference signal from each electromyograph signal in the set of electromyograph signals to generate a set of composite signals;
for each composite signal in the set of composite signals, transforming the composite signal into a spectrum of oscillating electromyograph components within a frequency range of interest; and
for each facial action unit in a set of facial action units:
calculating a confidence level associated with the facial action unit, based on the spectrum of oscillating electromyograph components and an action unit model; and
in response to the confidence level associated with the facial action unit exceeding a confidence threshold, outputting an identifier associated with the facial action unit.

16. The method of claim 15, further comprising, during a calibration period prior to the sampling interval, the calibration period comprising a set of calibration intervals corresponding in number to a set of facial expressions:
during each calibration interval:
prompting the user to display a facial expression in the set of facial expressions;
recording a calibration set of electromyograph signals through the set of sense electrodes;
deducting a calibration reference signal from each electromyograph signal in the calibration set of electromyograph signals to generate a set of composite calibration signals;
for each composite calibration signal in the set of composite signals, transforming the composite calibration signal into a calibration spectrum of oscillating electromyograph components in a set of calibration spectra of oscillating electromyograph components within the frequency range of interest;
selecting the action unit based on the set of calibration spectra corresponding to the set of facial expressions.

17. The method of claim 15, further comprising, during a calibration period prior to the sampling interval, the calibration period comprising a set of calibration intervals corresponding in number to a set of facial expressions:
during each calibration interval:
displaying a media item in the viewing window of the virtual reality headset designed to induce the user to display a facial expression in the set of facial expressions;
recording a calibration set of electromyograph signals through the set of sense electrodes;
deducting a calibration reference signal from each electromyograph signal in the calibration set of electromyograph signals to generate a set of composite calibration signals;
for each composite calibration signal in the set of composite signals, transforming the composite calibration signal into a calibration spectrum of oscillating electromyograph components in a set of calibration spectra of oscillating electromyograph components within the frequency range of interest;
selecting the action unit model based on the set of calibration spectra corresponding to the set of facial expressions.

18. The method of claim 17, wherein selecting the action unit model further comprises:
performing a cluster analysis of the set of calibration spectra and previous sets of calibration spectra, each cluster in the cluster analysis corresponding to a profile of the user; and
selecting the action unit model corresponding to the profile of the user.

19. The method of claim 15, further comprising, based on the identifier associated with the facial action unit, updating a virtual face of an avatar within a virtual environment to display a virtual facial action unit corresponding to the facial action unit.

20. The method of claim 15, wherein calculating a confidence level associated with the facial action unit further comprises:
accessing a set of identifiers of previously detected facial action units within a time buffer; and
calculating the confidence level associated with the facial action unit, based on temporal coherence between the previously detected facial action units within the time buffer and the facial action unit, the spectrum of oscillating electromyograph components, and the action unit model.
